(19) United States
(12) Patent Application Publication
(10) Pub. No.: US 2019/0295069 A1
(43) Pub. Date: Sep. 26, 2019

(54) SYSTEMS AND METHODS FOR INTEGRATING CRYPTOCURRENCY WALLET IDENTIFIERS WITH DIGITAL CERTIFICATES

(71) Applicant: CABLE TELEVISION LABORATORIES, INC, Louisville, CO (US)

(72) Inventors: Massimiliano Pala, Denver, CO (US); Brian A. Scriber, Denver, CO (US); Steven J. Goeringer, Westminster, CO (US)

(21) Appl. No.: 16/359,571

(22) Filed: Mar. 20, 2019

Related U.S. Application Data
(60) Provisional application No. 62/645,227, filed on Mar. 20, 2018.

(51) Int. Cl. G06Q 20/36; G06Q 20/38; G06Q 20/06

(52) U.S. Cl. CPC G06Q 20/3678; G06Q 2220/00; G06Q 20/0658; G06Q 20/3829

(57) ABSTRACT

A system for providing trust information associated with cryptocurrency wallets includes a wallet authority computer device. The wallet authority computer device is programmed to (i) receive, from a user computer device, a request for a digital certificate for at least one cryptographic wallet, (ii) validate the ownership of the at least one cryptographic wallet based on information contained in the request, (iii) generate a digital certificate for the at least one cryptographic wallet, and (iv) transmit, to the user computer device, the digital certificate.

### CROSS REFERENCE TO RELATED APPLICATIONS

This application claims the benefit of and priority to U.S. Provisional Patent Application No. 62/645,227, filed Mar. 20, 2018, entitled “CRYPTO CURRENCY WALLET IDENTIFIERS FOR DIGITAL CERTIFICATES,” the entire contents and disclosure of which is incorporated by reference in its entirety.

### BACKGROUND

The field of the disclosure relates to cryptocurrency systems, and more particularly, to systems and methods for providing trust of ownership of cryptocurrency.

Over the past several years cryptocurrencies have been more popular, with several varieties becoming available. However, most current crypto-currencies do not address the problem of securely identifying ownership other than through the address of associated wallets. In addition, many cryptocurrency systems do not allow multiple addresses to be associated with a single identity. These drawbacks are in contrast to the physical world, where individuals have multiple addresses, such as bank addresses, payment cards numbers, etc., associated with a single entity (e.g., a legal name).

Cryptocurrency wallets are software programs that store public and private cryptographic keys associated with an individual and interface with various digital ledgers (e.g., blockchains). Cryptocurrency wallets allow users to monitor their balance, send money, and conduct other operations. The public key allows other wallets to make payments to the wallet's address. The private key enables the transfer of cryptocurrency from that address. Wallets may be digital applications, or may be hardware based. Some wallets store the private key with the user, while other wallets have the private key stored remotely, and transactions are authorized by a trusted third party.

The wallet address is a public address, much like a cryptocurrency-specific account number. Each address is used to receive a specific type of cryptocurrency and is stored in the blockchain as the location associated with that specific piece of cryptocurrency, or “coin” (e.g., “Bitcoin” being one well-known example of a cryptocurrency coin). The wallet address associated with an individual may be shared publicly to allow the individual's wallet to receive cryptocurrency coins. The address itself relates back to all transactions associated with that address on a coin's blockchain.

When a first individual transmits coins, or any other type of cryptocurrency, to a second individual, the first individual is signing off ownership of the currency from their wallet address to the second individual's wallet's address. To be able to spend those coins and unlock the funds, the private key stored in the second individual's wallet must match the public address to which the individual unit of currency is assigned. If the public and private keys match, the balance in the second individual's (receiver) digital wallet will increase, and the balance of the first individual's (sender) will decrease accordingly. The transaction is signified merely by a transaction record on the blockchain and a change in balance in the corresponding cryptocurrency wallets.

Cryptocurrency wallets are pseudonymous. While the wallet itself is not necessarily tied to the identity of the user, all transactions from/to the wallet are stored publicly and permanently on the relevant immutable digital ledger/blockchain. Although the user's name, personal street address, etc. are not usually stored in the wallet, data such as the wallet address may be traced to the user's identity in a number of ways. However, many such tracing methods are difficult and/or time consuming for the person of ordinary skill in the art, and generally require special skills.

Many cryptocurrencies utilize a Public Key Infrastructure (PKI) to validate electronic signature. PKI uses a pair of cryptographic keys (e.g., one public and one private) to encrypt and decrypt data. PKI utilization enables, for example, devices to obtain and renew X.509 certificates, which are used to establish trust between devices and encrypt communications using such protocols as Transport Layer Security (TLS), etc. A PKI includes policies and procedures for encrypting public keys, as well as the creation, management, distribution, usage, storage, and revocation of digital certificates. The PKI binds the public keys to the identity of a person or legal entity, typically through a trusted Certificate Authority (CA). The PKI hierarchy identifies a chain of trust for a device or program, and further may provide secure software download requirements for the devices, and/or secure certificate injection requirements on the device manufacturers. The CA, the electronic devices, and users of the device interact over a PKI ecosystem.

It is therefore desirable to have systems and methods that provide more convenient and more possible techniques for associating individual identities to cryptocurrency wallet addresses, thereby improving the security, traceability, and accountability of cryptocurrency operations.

### SUMMARY

In an embodiment, a system for providing trust information associated with cryptocurrency wallets includes a wallet authority computer device having at least one processor in communication with at least one memory device. The at least one processor is programmed to (i) receive, from a user computer device, a request for a digital certificate for at least one cryptographic wallet, (ii) validate the ownership of the at least one cryptographic wallet based on information contained in the request, (iii) generate a digital certificate for the at least one cryptographic wallet, and (iv) transmit, to the user computer device, the digital certificate.

### BRIEF DESCRIPTION OF THE DRAWINGS

These and other features, aspects, and advantages of the present disclosure will become better understood when the following detailed description is read with reference to the following accompanying drawings, in which like characters represent like parts throughout the drawings.

FIG. 1 is a schematic illustration of a cryptocurrency wallet verification process, in accordance with an embodiment.

FIG. 2 is data flow diagram of a wallet ownership verification process, in accordance with an embodiment.

FIG. 3 is a data flow diagram of an alternative wallet ownership verification process, in accordance with an embodiment.

Unless otherwise indicated, the drawings provided herein are meant to illustrate features of embodiments of this disclosure. These features are believed to be applicable in a wide variety of systems including one or more embodiments of this disclosure. As such, the drawings are not meant to include all conventional features known by those of ordinary skill in the art to be required for the practice of the embodiments disclosed herein.

### DETAILED DESCRIPTION

In the following specification and the claims, reference will be made to a number of terms, which shall be defined to have the following meanings.

The singular forms “a,” “an,” and “the” include plural references unless the context clearly dictates otherwise.

“Optional” or “optionally” means that the subsequently described event or circumstance may or may not occur, and that the description includes instances where the event occurs and instances where it does not.

As used further herein, “CA” may refer to a certificate authority hosting a root certificate, and may further include, without limitation, one or more of a CA computer system, a CA server, a CA webpage, and a CA web service.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise.

As used herein, the terms “processor” and “computer” and related terms, e.g., “processing device,” “computing device,” and “controller” are not limited to just those integrated circuits referred to in the art as a computer, but broadly refers to a microcontroller, a microcomputer, a programmable logic controller (PLC), an application specific integrated circuit (ASIC), and other programmable circuits, and these terms are used interchangeably herein. In the embodiments described herein, memory may include, but is not limited to, a computer-readable medium, such as a random access memory (RAM), and a computer-readable non-volatile medium, such as flash memory. Alternatively, a floppy disk, a compact disc-read only memory (CD-ROM), a magneto-optical disk (MOD), and/or a digital versatile disc (DVD) may also be used. Also, in the embodiments described herein, additional input channels may be, but are not limited to, computer peripherals associated with an operator interface such as a mouse and a keyboard. Alternatively, other computer peripherals may also be used that may include, for example, but not be limited to, a scanner. Furthermore, in the exemplary embodiment, additional output channels may include, but not be limited to, an operator interface monitor.

Further, as used herein, the terms “software” and “firmware” are interchangeable, and include computer program storage in memory for execution by personal computers, workstations, clients, and servers.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

Furthermore, as used herein, the term “real-time” refers to at least one of the time of occurrence of the associated events, the time of measurement and collection of predetermined data, the time for a computing device (e.g., a processor) to process the data, and the time of a system response to the events and the environment. In the embodiments described herein, these activities and events occur substantially instantaneously.

In exemplary embodiments of the present systems and methods, an X.509 trust model is utilized, in which a trusted third party CA is responsible for signing digital certificates. Accordingly, as described herein, the CA may be presumed to have capability to store one or more trusted root certificates (or intermediate certificates) as well as the corresponding private keys. The CA may be further responsible for maintaining up-to-date revocation information regarding the validity of issued certificates, and will provide information to the other parties.

In exemplary operation, the CA issues PKI certificates and public keys to the entities, applications, or devices within the operational system. The CA receives request messages from these various participants and confirms the status of a corresponding certificate (e.g., stored in the trusted database of the CA). The CA then transmits a response message indicating the revocation status (e.g., “valid,” “revoked,” “unknown,” etc., or an error message if the request message may not be processed). In the exemplary embodiment, the CA generates or records the issuance of the public/private keypairs. In some embodiments, the CA further optionally generates/records the certificates associated with the keypairs. The generated keys may be for a single keypair, multiple keypairs for a single ecosystem, or multiple keypairs for different ecosystems.

The present systems and methods herein advantageously utilize distributed ledgers to manage and secure the cryptocurrencies. The distributed ledgers described and illustrated herein may include, for example, blockchain technology to create digital ledgers. For ease of explanation, the following description references a “blockchain,” or “blockchains,” as exemplary embodiments of distributed ledger technology. A person of ordinary skill in the art though, upon reading and comprehending the present description and associated illustrations, will understand that other examples of distributed ledger technologies may be implemented according to the novel and advantageous principles herein.

That is, in the following disclosure, the phrases “distributed ledger” and “blockchain” are used. In conventional practice literature, these two concepts are often considered to be synonymous. However, within this application, the two concepts may further differ in terms of their respective use and implementation. For example, in some instances the phrase “distributed ledger” may refer to how the ledger or blockchain is used, namely, the accessible distributed ledger as available to prove the facts of a transaction by virtue of being distributed amongst a consensus pool. A “blockchain,” on the other hand, may refer to the process by which the distributed ledger is created and operated. For example, a blockchain may create a distributed ledger, but a distributed ledger may be created by other technologies as well. In the following description, the phrase “digital ledger” may refer to either or both of a distributed ledger and a blockchain, and for ease of explanation, references to “blockchain” are intended to indicate a representative example of immutable ledger technology, but are not intended to be limited to blockchain embodiments only.

The present solutions may be advantageously implemented as standalone systems, or as complementary systems or subsystems to conventional systems that rely on trusted parties recording events into databases or other record keeping mechanisms, often using trusted labels.

According to the embodiments herein, digital ledgers are implemented to create secure and immutable records of transactions. In these records, the transaction information is encoded into formats, digitally signed using a cryptographic technique, and submitted to a network of processors of a distributed ledger network. These processors validate the submitted transactions for accuracy, and the validated transactions are subsequently added to a queue or stack of the immutable ledger. At some point, according to a predetermined criterion (such as, but not limited to, an interval of time, a volume of data, a number of transactions, or combination of these and other factors), the queued or stacked transactions are sequentially hashed (e.g., using a Merkle process), and collectively encoded into a block (e.g., in the case of blockchain) which is then hashed with the hash of the proceeding block using cryptographic processes. An algorithm will allow multiple processors to select a block from amongst many processors to be the block added to the blockchain.

In exemplary embodiments, the digital ledger is a blockchain. Exemplary systems and methods of digital ledgers and blockchain technology are described in greater detail in co-pending U.S. patent application Ser. No. 15/345,411, filed Nov. 7, 2016, U.S. patent application Ser. No. 15/376,375, filed Dec. 12, 2016, U.S. patent application Ser. No. 15/476,111, filed Mar. 31, 2017, and U.S. patent application Ser. No. 15/476,098, filed Mar. 31, 2017, all of which are incorporated by reference herein.

According to the present systems and methods, digital ledger techniques may be utilized to better secure information and transactions from consumers. The principles described herein may be applicable to simple currency transactions or negotiations (e.g., Bitcoin exchanges) between parties, and/or non-financial consumer information or content in general. That is, the private consumer information may be considered as the “currency” to which the present embodiments may be advantageously employed. Such nonfinancial content, for purposes of this discussion, includes, but is not limited to, smart contracts, shared media, software, copyrighted works, licenses, security credentials, and other forms of transferable content that are not strictly currency only. Such information is sometimes referred to as “licensed-burdened content,” “valuable encumbered content,” or “Content as Currency” (CAC).

As described above, blockchaining utilizes cryptographic techniques to create digital ledgers of transactions. According to the systems and methods described herein, the application of blockchaining to CAC transactions has wide applicability to companies desiring, or required, to increase the security of information/transactions over networks. In addition to CAC information, the present embodiments will further significantly increase the privacy security in areas including, without limitation: smart contracts; enhanced content protection; digital rights management (DRM); secure imaging; distributed denial of service (DDoS) mitigation and/or attacks; scalable Internet of Things (IoT) security solutions; supply chain integrity; device registration, and enhanced DRM and data over cable service interface specification (DOCSIS) security; enhanced content protection; connectivity negotiation; dynamic service creation or provisioning; service authentication; virtualization orchestration; and billing transformation.

The embodiments described herein provide systems and methods for validating ownership of a wallet address or identifier and providing secured information to others to generate trust for the wallet.

In the exemplary embodiment, an enhanced digital certificate is used to provide wallet information to facilitate cryptocurrency transfers between wallets. The enhanced digital certificate includes information related to the trusted authority that issued the digital certificate as well as wallet information such as one or more wallet addresses. In the exemplary embodiment, the enhanced digital certificate provides the information necessary to transfer cryptocurrency funds to the wallet as well as provides trust information ensuring that the wallet information is trusted and assuring that the user that the owner of the wallet has been verified.

The system allows a cryptocurrency wallet owner to request an enhanced digital certificate to be associated with their cryptocurrency wallets. In some embodiments, a wallet owner may have an enhanced digital certificate for each cryptocurrency wallet that they own. In other embodiments, the wallet owner has a single enhanced digital certificate that contains information for all of their cryptocurrency wallets. In some embodiments, the enhanced digital certificate is an X.509 certificate with X.509 extensions embedded in the certificate. In these embodiments, the extensions contain the information about the wallets associated with the subject of the certificate. This may be v3, v4, or subsequent versions of the X.509 certificate. For the purposes of digital currencies, the digital certificate extension may include a unique currency identifier, such as, but not limited to an object identifier (OID); a wallet address for that currency, a currency ticker, such as a common acronym (e.g., BTC for Bitcoin); the name or description of the currency, such as a common full name (e.g., Bitcoin Cash); a public key associated with the wallet address, and an identifier of the secret used to protect the wallet, such as a hash of the public key.

In the following embodiments, “blockchain” refers to a distributed database that is capable of maintaining a continuously-growing list of ordered records, known as blocks. Each block may contain at least a timestamp and a link to the previous block in the chain. The link to the previous block may be a hash of the previous block. For storing consumer information, the first block may contain personal information for a first consumer. The second block may store personal information for a second consumer. The second block may contain a hashed copy of the first block as well. The third block may contain changes or updates to the opt-in/out choices for the first consumer. This process continues, with each block adding on to the next block, while containing a hash of the previous blocks in the blockchain.

To ensure the security of the information contained in the blockchain, copies of the blockchain may be distributed across multiple computer devices, known as nodes. These nodes maintain the blockchain, update the blockchain when changes occur, and ensure the stability of the blockchain itself. In some embodiments, nodes may be also used to calculate the hash of the previous blocks. As the blockchain grows, the processing power needed to calculate the hash of the previous blocks grows as well. In these embodiments, the processing of the hash may be distributed over multiple computer devices to improve the speed of processing and/or to not overburden the hashing processor. When a node processes (hashes) a block, that node is known as a miner, where the action of validating and hashing the block is also known as mining.

For a cryptocurrency, the blockchain stores information about the ownership of individual units of the cryptocurrency. This includes the identifiers (e.g., wallet identifiers of the accounts associated with transactions). When a first individual transmits bitcoins or any other type of cryptocurrency to a second individual, the first individual is signing off ownership of the currency from their wallet address to the second individual's wallet's address. To be able to spend those coins and unlock the funds, the private key stored in the second individual's wallet must match the public address that the individual units of currency are assigned to. If the public and private keys match, the balance in the second individual's digital wallet will increase, and the sender's will decrease accordingly. The transaction is signified merely by a transaction record on the blockchain and a change in balance in the corresponding cryptocurrency wallets.

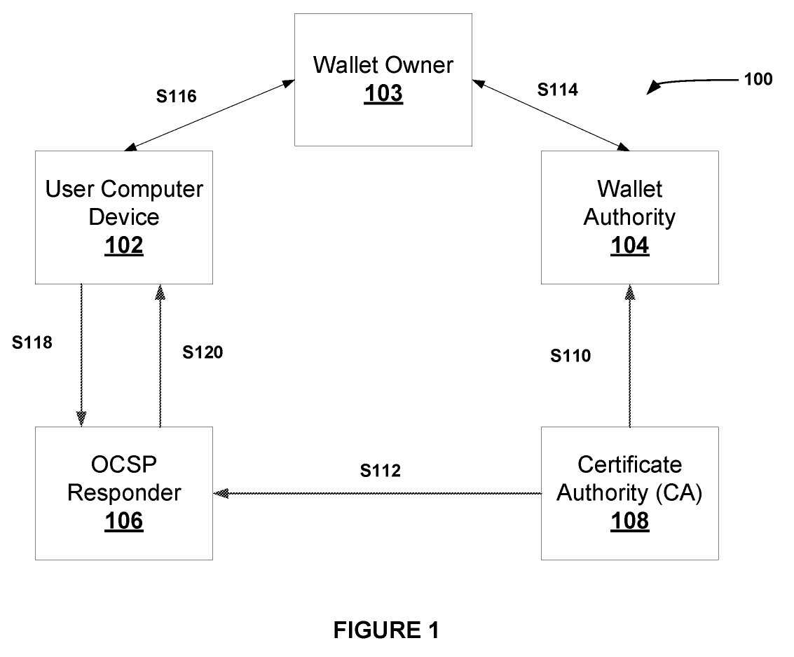

FIG. 1 is a schematic illustration of a cryptocurrency wallet verification process 100. In an exemplary embodiment, process 100 is implemented with respect to a user computer device 102, a wallet owner 103, a wallet authority 104, an Online Certificate Status Protocol (OCSP) server 106, and a CA 108.

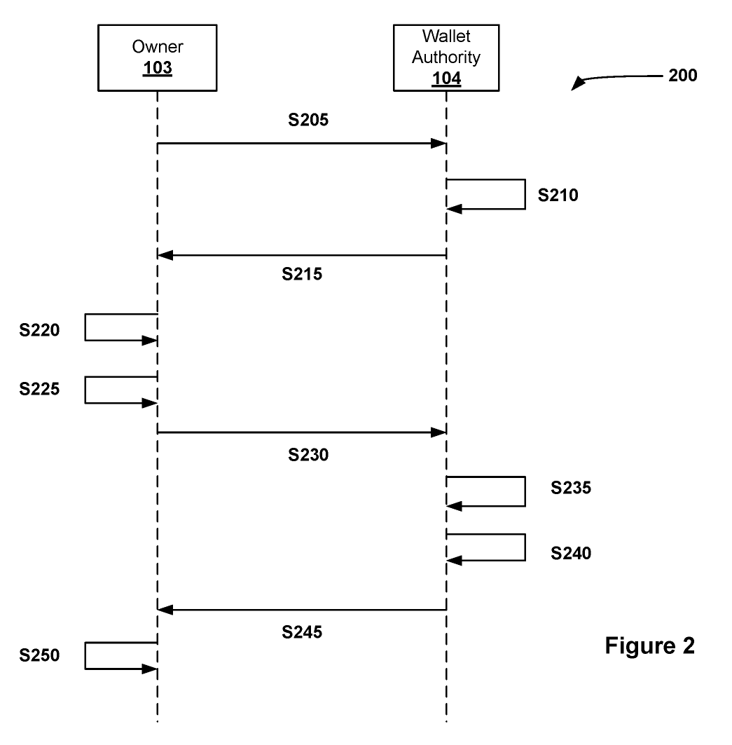

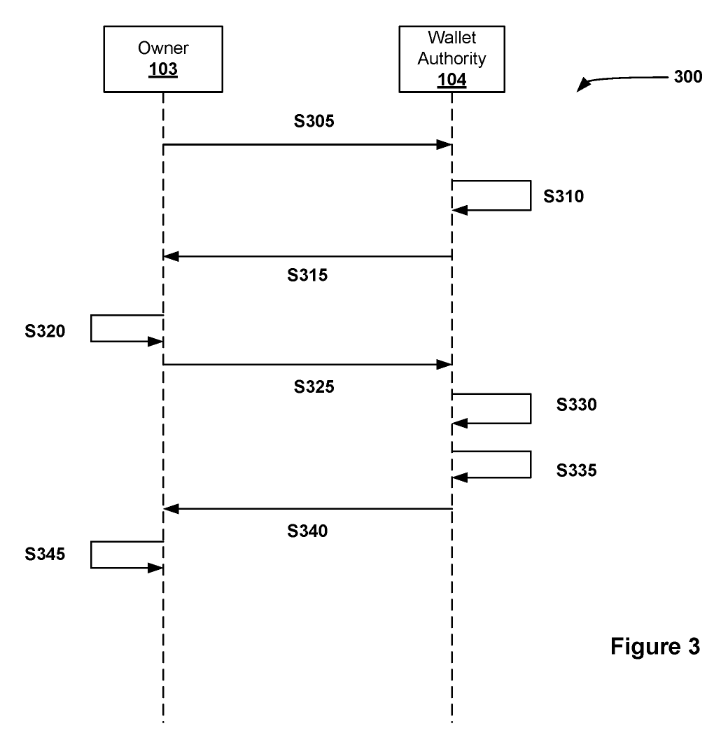

In exemplary operation, process 100 begins at step S110, in which CA 108 provides 110 a cryptocurrency wallet digital certificate to wallet authority 104 to generate a trust level for the wallet authority 104 (described further below with respect to FIGS. 2 and 3). In step S112, CA 108 provides the status of the digital certificate to OCSP server 106, also referred to as an OCSP responder 106. In some embodiments of step S112, the CA 108 provides another update to the status of the digital certificate to the OCSP responder 106 whenever that status changes. In step S114, the wallet authority 104 provides the cryptocurrency wallet digital certificate to the wallet owner 103. The wallet owner 103 is the individual in possession of a digital wallet for cryptocurrency.

In the exemplary embodiment, the cryptocurrency wallet digital certificate is an enhanced digital certificate that contains information about one or more wallet addresses possessed by the wallet owner 103. For the purposes of cryptocurrencies, the cryptocurrency wallet digital certificate may include a unique currency identifier, such as, but not limited to an object identifier (OID); a wallet address for that currency, a currency ticker, such as a common acronym (e.g., BTC for Bitcoin); the name or description of the currency, such as a common full name (e.g., Bitcoin Cash); a public key associated with the wallet address, and an identifier of the secret used to protect the wallet, such as a hash of the public key. In some embodiments, the wallet address is the public key. The cryptocurrency wallet digital certificate may include more or less information as necessary to perform the functions as described herein. In some embodiments, the cryptocurrency wallet digital certificate includes multiple wallet address for multiple types of cryptocurrencies. In some embodiments, multiple addresses may be associated with different wallets such as at different currency exchanges.

In further exemplary operation of process 100, in step S116, user computer device 102 requests a wallet address from the wallet owner 103. For example, the user computer device 102 may be requesting the wallet address to transfer cryptocurrency into the wallet. In some embodiments, this request may be a part of a financial transaction, such as purchasing a good or service using user computer device 102. In some embodiments, wallet owner 103 may be an entity, such as a corporation or business, and the user computer device 102 is transferring cryptocurrency funds to the entity. In an exemplary embodiment of step S116, rather than simply transmitting the wallet address, the wallet owner 103 transfers the cryptocurrency wallet digital certificate associated with that wallet address.

The user computer device 102 may then verify the information related to the revocation status of the provided digital certificate. The user computer device 102 determines from which server this information may be retrieved. In some embodiments, the address of the OCSP responder 106 is located in the digital certificate. In other embodiments, the user computer device 102 includes one or more locally configured options that allow device 102 to request the revocation status of the digital certificate. Accordingly, in step S118, the user computer device 102 transmits a query (an OCSP request) to the OCSP responder 106 to determine the status of the digital certificate. In step S120, the OCSP responder 106 responds with an OCSP response that includes the revocation status of the digital certificate. In an exemplary embodiment of step S120, if the certificate has not associated revocation information, the OCSP response will include a non-revoked status. In some embodiments, such as in situations validating not only the revocation information, but also the existence of the digital certificate, the OCSP response may include an extension that provides the requesting party with the hash of the certificate requested.

Once the user computer device 102 has verified the status of the cryptocurrency wallet digital certificate, the user computer device 102 may then use the wallet address included in the cryptocurrency wallet digital certificate to perform a cryptocurrency transaction.

The user computer device 102, may include, but is not limited to point of sale (PoS) device, a client computing device (e.g., a smartphone, tablet, laptop, desktop computing device, wearable, or other computing device), or another type of device that allows the system to operate as described herein.

The respective processes depicted in FIGS. 2 and 3 are described with respect to execution by, or in relation to various elements, including one or more of wallet owner 103 and wallet authority 104, FIG. 1. Several of these elements may be considered similar in structure and function to elements described above using the same respective labels. However, the person of ordinary skill in the art will understand that exemplary elements are provided for ease of illustration, and are not intended to be limiting. That is, the operation of the following processes is not limited strictly to the specific elements provided in the examples, nor are the several elements limited to the exemplary descriptions provided throughout this description.

FIG. 2 is data flow diagram of a wallet ownership verification process 200. In an exemplary embodiment of process 200, wallet owner 103 proves ownership of a wallet (not separately shown). In an embodiment, the wallet owner 103 uses computer device 102 to register one or more wallet addresses by proving ownership of the relevant wallet addresses.

In some embodiments, process 200 occurs the first time the wallet owner 103 requests a digital certificate for the wallet. In other embodiments, process 200 occurs every time that wallet owner 103 updates one of the wallets.

In exemplary operation, process 200 begins at step S205, in which the owner 103 requests a certificate for one or more wallets. In step S210, the wallet authority responds by generating a nonce. A nonce is an arbitrary/random number that can be used just once in a cryptographic communication. In step S215, the wallet authority 104 transmits the nonce to the owner 103. In step S220, for each wallet address that the owner desires to include in the digital certificate, the owner 103 encrypts the nonce using the private key associated with that wallet address. The encrypted nonce is provided as proof of possession of the wallet address. In some embodiments, a single nonce is provided and encrypted. In other embodiments, multiple nonces are provided, one per wallet address. In these embodiments, the owner 103 encrypts each nonce with the private key associated with the corresponding wallet address, such as in a one to one basis.

In step S225, the owner 103 then generates the certificate request. In the exemplary embodiment, the certificate request includes the wallet address, public key, and the private key encrypted nonce. In some embodiments, the certificate request may include multiple sets of data, such as for multiple wallet addresses.

In step S230, the owner 103 transmits S230 the certificate request to the wallet authority 104. In step S235, the wallet authority 104 verifies the proof of possession by decrypting the nonce using the public key for each of the wallet addresses. In step S240, if the nonce is properly decrypted, the wallet authority 104 generates the enhanced digital certificate based on the information in the certificate request. In an embodiment of step S240, the wallet authority 104 generates the enhanced digital certificate internally. In other embodiments of step S240, the wallet authority 104 transmits the information in the certificate request to CA 108 (shown in FIG. 1) to generate the enhanced digital certificate. In step S245, the wallet authority 104 transmits the enhanced digital certificate to the owner 103. In step S250, the owner 103 verifies the information in the enhanced digital certificate.

FIG. 3 is a data flow diagram of a wallet ownership verification process 300. In an exemplary embodiment of process 300, wallet owner 103 proves ownership of a wallet. In some embodiments, process 300 occurs the first time the wallet owner 103 requests a digital certificate for the wallet. In other embodiments, process 300 occurs every time that wallet owner 103 updates one of the wallets.

In exemplary operation of process 300, at step S305, the owner 103 requests a certificate for one or more wallets. In an embodiment of step S305, the request includes the wallet address and the corresponding public key. In some embodiments, the certificate request may include multiple sets of data, such as for multiple wallet addresses.

In step S310, the wallet authority 104 generates a new wallet address (RWA) for each of the presented wallet addresses. In step S315, the wallet authority 104 transmits a transaction request for each RWA. That is, if the owner 103 sent three wallet addresses, then the wallet authority 104 requests three transactions, one from each wallet address. In the exemplary embodiment, each transaction request is for a small amount of cryptocurrency. In some embodiments, this amount is a transaction fee for generating the enhanced digital certificate.

In step S320, for each transaction requested, the owner 103 generates a transaction transferring the request amount from the owner's wallet address to the wallet address (RWA) generated by the wallet authority 104. In step S325, the owner 103 transfers the requested amounts to the wallet authority 104. In step S330, the wallet authority 104 verifies the transactions to be valid transactions. By being able to perform a transaction with this verified wallet address, the owner 103 has provided proof of possession.

In step S335, for each valid transaction, the wallet authority 104 generates the enhanced digital certificate based on the information in the original request. In some embodiments of step S335, the wallet authority 104 generates the enhanced digital certificate internally. In other embodiments of step S335, the wallet authority 104 transmits the information in the certificate request to a CA 108 (shown in FIG. 1) to generate the enhanced digital certificate. In step S340, the wallet authority 104 transmits the enhanced digital certificate to the owner 103. In step S345, the owner 103 verifies the information in the enhanced digital certificate.

The computer-implemented methods discussed herein may include additional, fewer, or alternate actions, including those discussed elsewhere herein. These various methods, as well as one or more of their respective subprocesses, may be implemented by one or more local or remote processors, transceivers, and/or sensors (such as processors, transceivers, and/or sensors mounted on vehicles or mobile devices, or associated with smart infrastructure or remote servers), and/or via computer-executable instructions stored on non-transitory computer-readable media or medium.

Additionally, the computer systems discussed herein may include additional, fewer, or alternate functionality, including that discussed elsewhere herein. The computer systems discussed herein may include or be implemented via computer-executable instructions stored on non-transitory computer-readable media or medium.

The exemplary embodiments described herein provide a cryptocurrency security management system that is advantageously disposed to generate trust during cryptocurrency transactions. The cryptocurrency security management system thus functions as a midbox capable of: (i) securely storing cryptographic wallet information; (ii) providing a trust level to wallet addresses for cryptographic transactions; (iii) combining cryptographic wallet addresses with trust information for ease of secure dissemination; and (iv) combining the wallet information for multiple wallets associated with the same entity.

The aspects described herein may be implemented as part of one or more computer components such as a client device and/or one or more back-end components, such as a blockchain nodes and wallet programs, for example. Furthermore, the aspects described herein may be implemented as part of a computer network architecture and/or a cognitive computing architecture that facilitates securely storing and selectively releasing cryptographic wallet information. Thus, the aspects described herein address and solve issues of a technical nature that are necessarily rooted in computer technology.

For instance, aspects include providing trust information associated with cryptocurrency wallets. In doing so, the aspects overcome issues associated with having little to no information proving that the entity providing the wallet address is the owner of the wallet. Furthermore, these aspects reduce the chance of compromise of cryptographic wallets. Without the improvements suggested herein, additional processing and memory usage, or even direct human intervention, would be required to perform such activities. Additional technical advantages that are provided by the present embodiments include, but are not limited to: (i) improved proof of possession of a wallet; (ii) stake based participation in the cryptocurrency by the user; (iii) higher level cryptocurrency ownership verification; (iv) simpler transfer of funds between commonly owned wallets, such as between cryptocurrency exchanges; (v) reduced chances of incorrectly entering wallet addresses; and (vi) a system more reliably verifying cryptocurrency transfers.

Furthermore, the embodiments described herein improve upon existing technologies, and improve the functionality of computers, by more accurately storing the latest consumer personal information and decisions. The present embodiments improve the speed, efficiency, security, and storage space required in which such methods may be performed. Due to these improvements, the present embodiments significantly improve the efficiency and operation of computers and computer-related processes in comparison with conventional techniques. The present techniques thus additionally improve computer-centric technology related to the privacy of consumer information.

Accordingly, the innovative systems and methods described herein are of particular value within the realm of cryptocurrency security, which have been historically associated with a poor record of securing cryptocurrency stored in wallets. The present embodiments enable more reliable updating and control of such information, but without compromising data and security. Furthermore, according to the disclosed techniques, consumers are better able to ensure that those that they transmit cryptocurrency to and from are those that own the corresponding accounts. Moreover, the ability to more reliably track cryptocurrency transfer, but without adding additional risk to consumer data, greatly enhances the ability of ensure cryptocurrency wallets remain secure.

Exemplary embodiments of systems and methods for providing trust information associated with cryptocurrency wallets are described above in detail. The systems and methods of this disclosure though, are not limited to only the specific embodiments described herein, but rather, the components and/or steps of their implementation may be utilized independently and separately from other components and/or steps described herein.

Although specific features of various embodiments may be shown in some drawings and not in others, this is for convenience only. In accordance with the principles of the systems and methods described herein, any feature of a drawing may be referenced or claimed in combination with any feature of any other drawing.

Some embodiments involve the use of one or more electronic or computing devices. Such devices typically include a processor, processing device, or controller, such as a general purpose central processing unit (CPU), a graphics processing unit (GPU), a microcontroller, a reduced instruction set computer (RISC) processor, an application specific integrated circuit (ASIC), a programmable logic circuit (PLC), a programmable logic unit (PLU), a field programmable gate array (FPGA), a digital signal processing (DSP) device, and/or any other circuit or processing device capable of executing the functions described herein. The methods described herein may be encoded as executable instructions embodied in a computer readable medium, including, without limitation, a storage device and/or a memory device. Such instructions, when executed by a processing device, cause the processing device to perform at least a portion of the methods described herein. The above examples are exemplary only, and thus are not intended to limit in any way the definition and/or meaning of the term processor and processing device.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system for providing trust information associated with cryptocurrency wallets comprising a wallet authority computer device comprising at least one processor in communication with at least one memory device, and wherein the at least one processor programmed to:
receive, from a user computer device, a request for a digital certificate for at least one cryptographic wallet;
validate the ownership of the at least one cryptographic wallet based on information contained in the request;
generate a digital certificate for the at least one cryptographic wallet; and
transmit, to the user computer device, the digital certificate.

2. The system in accordance with claim 1, wherein the digital certificate includes at least one wallet address associated with the at least one cryptographic wallet.

3. The system in accordance with claim 2, wherein the digital certificate also includes at least one of a public key, a currency identifier, and a wallet identifier for each wallet address of the at least one wallet address.

4. The system in accordance with claim 1, wherein the at least one processor is further programmed to:
transmit a nonce to the user computer device in response to the request;
receive a certificate request including an encrypted nonce; and
validate the ownership based on the encrypted nonce.

5. The system in accordance with claim 4, wherein the encrypted nonce is encrypted by user computer device using the private key associated with the at least one cryptographic wallet.

6. The system in accordance with claim 5, wherein the certificate request contains the public key associated with the at least one cryptographic wallet, and wherein the at least one processor is further programmed to:
decrypt the encrypted nonce using the public key;
compare the decrypted nonce to the nonce transmitted to the user computer device; and
validate the ownership based on the comparison.

7. The system in accordance with claim 4, wherein the certificate request contains at least one of a public key, a currency identifier, and a wallet identifier for each wallet address of the at least one wallet address.

8. The system in accordance with claim 1, wherein the at least one processor is further programmed to:
transmit a single nonce to the user computer device; and
receive a certificate request including a plurality of encrypted nonces, wherein each encrypted nonce is encrypted with a private key associated with a wallet address of the plurality of wallet addresses.

9. The system in accordance with claim 1, wherein the at least one processor is further programmed to:
transmit a plurality of nonces, wherein each nonce of the plurality of nonces corresponds to one of a plurality of wallet addresses; and
receive a plurality of encrypted nonces in the certificate request, wherein each encrypted nonce of the plurality of encrypted nonces is encrypted with one of the private keys corresponding to one of the plurality of wallet addresses.

10. The system in accordance with claim 9, wherein the at least one processor is further programmed to validate each of the plurality of wallet address based on the decrypted version of the encrypted nonce matching the originally transmitted nonce.

11. The system in accordance with claim 1, wherein the at least one processor is further programmed to receive a certificate request for a plurality of wallet addresses, wherein each wallet address of the plurality of wallet addresses is associated with a cryptocurrency wallet.

12. The system in accordance with claim 1, wherein the at least one processor is further programmed to:
generate a new wallet address to correspond to the at least one digital wallet;
generate a transaction request for each new wallet address; and
transmit the transaction request to the user computer device.

13. The system in accordance with claim 12, wherein the transaction request is for a transfer of an amount of cryptocurrency from the at least one wallet to the corresponding new wallet address.

14. The system in accordance with claim 13, wherein the at least one processor is further programmed to validate ownership of the at least one wallet based on receiving the amount of cryptocurrency from the at least one wallet.

15. The system in accordance with claim 1, wherein the at least one processor is further programmed to request a certificate authority generate the digital certificate.
